(19) United States
(12) Patent Application Publication
(10) Pub. No.: US 2008/0072641 A1
(43) Pub. Date: Mar. 27, 2008

(54) DUST CONTROL OF SOLID GRANULAR MATERIALS

(75) Inventor: Mark Ogzewalla, Mulberry, FL (US)

Correspondence Address: DENNIS G. LAPOINTE;LAPOINTE LAW GROUP, PL, PO BOX 1294, TARPON SPRINGS, FL, 34688-1294, US

(73) Assignee: ARR-MAZ CUSTOM CHEMICALS, INC., Mulberry, FL (US)

(21) Appl. No.: 11/838,910

(22) Filed: Aug. 15, 2007

Related U.S. Application Data
(60) Provisional application No. 60/839,871, filed on Aug. 24, 2006.

(51) Int. Cl. C05G 3/10

(52) U.S. Cl. 71/64.07

(57) ABSTRACT

A method and composition for controlling dust and anti-caking of solid granular materials, including fertilizers, aggregates, minerals and ores wherein a glycerin which has been reacted with a polybasic acid for producing the composition is applied to the solid granular materials.

### RELATED APPLICATION

This application claims the benefit of U.S. Provisional Patent Application Ser. No. 60/839,871 filed Aug. 24, 2006.

### FIELD OF THE INVENTION

This invention relates to a dust control composition for solid granular materials such as fertilizers, aggregates, minerals and ores, for the purpose of reducing the initial dust levels present in such materials, reducing subsequent dust formation, and to reduce the tendency of the material particles to agglomerate or cake during storage and transportation,

### BACKGROUND OF THE INVENTION

Solid granular materials such as fertilizers, aggregates, minerals and ores are subject to dust formation during their manufacture, transportation, storage, and eventual use. Fertilizers such as ammonium phosphate, potash, granulated single super phosphate, triple super phosphate, ammonium sulfate, potassium nitrate, ammonium nitrate, and urea, and combinations of these to form so called NP or NPK fertilizers are subject to dust formation during their manufacture, transportation, storage, and eventual use at the farm or home. This holds true for many other solid granular materials of which some examples are: aggregates used in construction and other industrial applications, borax, which is used in many industrial applications, and calcium phosphates, which are used as animal feed ingredients as well as other applications. Dust from these solid granular materials can pose safety, health, environmental, housekeeping, and maintenance problems for producers, distributors and consumers.

The use of oils and waxes as coatings to control dust formation is well known. However, the use of these petroleum derived materials is often perceived as a possible environmental issue and more “greener” or more easily biodegradable products for coatings are sought.

### SUMMARY OF THE INVENTION

The present invention, is the discovery of a method of controlling both initial and subsequent dust formation by coating the fertilizer particles with an environmentally friendly material.

Glycerin has been used as a coating agent for solid granular materials such as fertilizer but has limited effectiveness in view of its humectant properties and its poor dust binding or holding properties. It rapidly loses its ability to control dust over time. Glycerin promotes caking as it absorbs moisture from the atmosphere. This absorbed moisture promotes crystal growth on granule surfaces and crystal bridging between individual granules which causes caking to occur.

It has been discovered that if the glycerin is reacted with a polybasic acid such as citric acid, and the resultant product is used to coat a solid granular material such as fertilizer, the initial excellent control of dust and reduction in caking tendencies is maintained for a prolonged time. In addition, the coating is both biodegradable and non-toxic,

### DETAILED DESCRIPTION OF THE INVENTION

As mentioned above, if the glycerin is reacted with a polybasic acid such as citric acid, and the resultant product is used to coat a solid granular material such, as fertilizer, tire initial excellent control of dust and caking is maintained for a prolonged time. In addition, the coating is both biodegradable and non-toxic.

Tables 1-5 below provide examples of the improved dust control obtained by the present invention with various solid granular materials, including granulated borax, di-calcium phosphate, tri-calcium phosphate, mono-ammonium phosphate and di-ammonium phosphate. Dust levels were determined using a dust tower similar to that described In the “Manual for Determining Physical Properties of Fertilizer” 2^{nd} edition, 1993, International Fertilizer Development Center, Muscle Shoals, Alabama, at pages 69-72. In this test the granular solid particles are passed through a counter current air stream and are agitated at the same time by passing through a series of grates. The dust particles are collected on a filter and the dust levels determined by measuring the changes in weight on an analytical balance. Dust levels were determined both initially after treatment with the de-dusting agents and again after aging for 14 days in a 140° F. (60° C.) oven. After removal from the oven the samples are allowed to cool for 24 hours. This aging process is designed to simulate the increase in dust levels normally encountered during the storage of granular solid materials.

Table 1 demonstrates the effectiveness of glycerin reacted with citric acid, in a 1 to 0.1ratio, in controlling dust on granular borax. Initial dust levels were determined after the borax was treated with mineral oil, vegetable oil and two commercial de-dusting agents at two application rates, 1.0 and 2.0 gallons per ton.

Tables 2 and 3 demonstrate the effectiveness of glycerin reacted with citric acid, in a 1 to 0.1 ratio and 1 to 0.2 ratio, in controlling dust on granular di-calcium phosphate and granular tri-calcium phosphate. Both initial dust levels and aged dust levels were determined after the calcium phosphates were treated with three commercial de-dusting agents suitable for use on animal feed ingredients at two application rates, 1.0 and 2.0 gallons per ton.

Tables 4 and 5 demonstrate the effectiveness of glycerin reacted with citric acid, in a 1 to 0.2 ratio and 1 to 0.8 ratio, in controlling dust on granular mono-ammonium phosphate and granular di-ammonium phosphate. Both initial dust levels and aged dust levels were determined after the ammonium phosphates were treated with mineral oil and two different commercial de-dusting agents, at application rates of 0.5 gallons per ion.

DUSTROL® or KGA™ de-dusting agents are commercial dust control agents, all manufactured and sold by ARR-MAZ Custom Chemicals, Inc., of Mulberry, Fla., US.

Accordingly, the invention is a dust control composition for fertilizers comprising a composition for coating fertilizer in which glycerin is reacted with a polybasic acid for producing said composition. A preferred polybasic acid is citric acid.

The preferred ratio of the polybasic acid to glycerin can be from 0.05 to 1 to 1 to 1, depending on the viscosity requirements for application to the fertilizer, and the desired application amount can range from 0.5 to 40 pounds per ton of fertilizer material.

The invention also includes a method for controlling dust and anti-caking of solid granular materials comprising applying to the material a coating composition comprising glycerin which has been reacted with a polybasic acid for producing said composition, as described above.

Fir purposes of unit conversion throughout this written description, in the United States, one ton is considered to be 2000 pounds or sometimes referred to as a short ion. A ton is equal to 0.9 tonnes (or 0.9 metric tons). A pound is equal to 0.45 kilograms (kg) and a gallon is equal to 3.8 liters. In addition, a temperature in ° C. is equal to 5/9(temperature in ° F−32).

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

### Dust Tests with Granulated Borax

TABLE 1

| | | Application | Application | | |
|---|---|---|---|---|---|
| | | Rate | Rate | Dust Levels | Reduction in |
| | Specific | (Gallons per | (Pounds per | (Part per | Dust Levels |
| De-Dusting Agent | Gravity | Ton) | Ton) | Million) | (%) |
| None | NA | 0.0 | 0.0 | 15,850 | 0.0 |
| Mineral Oil | 0.914 | 1.0 | 7.6 | 9,150 | 42.3 |
| DUSTROL 3082 | 0.924 | 1.0 | 7.7 | 2,350 | 85.2 |
| Vegetable Oil | 0.890 | 1.0 | 7.3 | 3,900 | 75.4 |
| DUSTROL 3876 | 1.260 | 1.0 | 10.6 | 1,400 | 91.2 |
| Glycerin Citric Acid | 1.340 | 1.0 | 11.2 | 1,100 | 93.1 |
| (1 to 0.1) | | | | | |
| None | NA | 0.0 | 0.0 | 15,850 | 0.0 |
| Mineral Oil | 0.914 | 2.0 | 15.2 | 8,365 | 47.2 |
| DUSTROL 3082 | 0.924 | 2.0 | 15.4 | 1,754 | 88.9 |
| Vegetable Oil | 0.890 | 2.0 | 14.9 | 3,580 | 77.4 |
| DUSTROL 3876 | 1.260 | 2.0 | 21.1 | 1,175 | 92.6 |
| Glycerin Citric Acid | 1.340 | 2.0 | 22.3 | 865 | 94.5 |
| (1 to 0.1) | | | | | |

### Dust Tests with Di-Calcium Phosphate

TABLE 2

| | | Application | Application | | | Total Dust | |
|---|---|---|---|---|---|---|---|
| | | Rate | Rate | Initial Dust | Reduction in | Levels after | Reduction in |
| | Specific | (Gallons per | (Pounds per | Levels (Part | Initial Dust | Aging (Part | Total Dust |
| De-Dusting Agent | Gravity | Ton) | Ton) | per Million) | Levels (%) | per Million) | Levels (%) |
| None | NA | 0.0 | 0.0 | 2,850 | 0.0 | 5,400 | 0.0 |
| KGA 200 | 1.209 | 1.0 | 10.1 | 2,350 | 17.5 | 4,700 | 13.0 |
| KGA 700 | 1.243 | 1.0 | 10.4 | 1,650 | 42.1 | 2,900 | 46.3 |
| KGA 517 | 1.200 | 1.0 | 10.0 | 2,300 | 19.3 | 5,200 | 3.7 |
| Glycerin Citric Acid | 1.340 | 1.0 | 11.2 | 2,450 | 14.0 | 4,650 | 13.9 |
| (1 to 0.1) | | | | | | | |
| Glycerin Citric Acid | 1.348 | 1.0 | 11.3 | 1,000 | 64.9 | 1,850 | 65.7 |
| (1 to 0.2) | | | | | | | |
| None | NA | 0.0 | 0.0 | 2,850 | 0.0 | 5,400 | 0.0 |
| KGA 200 | 1.209 | 2.0 | 20.2 | 2,300 | 57.4 | 4,750 | 12.0 |
| KGA 700 | 1.243 | 2.0 | 20.7 | 1,100 | 79.6 | 2,250 | 58.3 |
| KGA 517 | 1.200 | 2.0 | 20.0 | 2,250 | 58.3 | 4,800 | 11.1 |
| Glycerin Citric Acid | 1.340 | 2.0 | 22.4 | 2,050 | 62.0 | 3,850 | 28.7 |
| (1 to 0.1) | | | | | | | |
| Glycerin Citric Acid | 1.348 | 2.0 | 22.6 | 650 | 88.0 | 1,400 | 74.1 |
| (1 to 0.2) | | | | | | | |

### Dust Tests with Tri-Calcium Phosphate

TABLE 3

| | | Application | Application | | | Total Dust | |
|---|---|---|---|---|---|---|---|
| | | Rate | Rate | Initial Dust | Reduction in | Levels after | Reduction in |
| | Specific | (Gallons per | (Pounds per | Levels (Part | Initial Dust | Aging (Part | Total Dust |
| De-Dusting Agent | Gravity | Ton) | Ton) | per Million) | Levels (%) | per Million) | Levels (%) |
| None | NA | 0.0 | 0.0 | 8,400 | 0.0 | 16,300 | 0.0 |
| KGA 200 | 1.209 | 1.0 | 10.1 | 1,950 | 76.8 | 3,150 | 80.7 |
| KGA 700 | 1.243 | 1.0 | 10.4 | 2,200 | 73.8 | 3,600 | 77.9 |
| KGA 517 | 1.200 | 1.0 | 10.0 | 5,250 | 37.5 | 9,200 | 43.6 |
| Glycerin Citric Acid | 1.340 | 1.0 | 11.2 | 1,500 | 82.1 | 2,050 | 87.4 |
| (1 to 0.1) | | | | | | | |
| Glycerin Citric Acid | 1.348 | 1.0 | 11.3 | 1,100 | 86.9 | 1,700 | 89.6 |
| (1 to 0.2) | | | | | | | |
| None | NA | 0.0 | 0.0 | 8,400 | 0.0 | 16,300 | 0.0 |
| KGA 200 | 1.209 | 2.0 | 20.2 | 1,000 | 93.9 | 2,500 | 84.7 |
| KGA 700 | 1.243 | 2.0 | 20.7 | 1,150 | 92.9 | 2,400 | 85.3 |
| KGA 517 | 1.200 | 2.0 | 20.0 | 1,400 | 91.4 | 3,700 | 77.3 |
| Glycerin Citric Acid | 1.340 | 2.0 | 22.4 | 1,000 | 93.9 | 2,150 | 86.8 |
| (1 to 0.1) | | | | | | | |
| Glycerin Citric Acid | 1.348 | 2.0 | 22.6 | 600 | 96.3 | 1,000 | 93.9 |
| (1 to 0.2) | | | | | | | |

### Dust Tests with Mono-Ammonium Phosphate

TABLE 4

| | | Application | Application | | | Total Dust | |
|---|---|---|---|---|---|---|---|
| | | Rate | Rate | Initial Dust | Reduction in | Levels after | Reduction in |
| | Specific | (Gallons per | (Pounds per | Levels (Part | Initial Dust | Aging (Part | Total Dust |
| De-Dusting Agent | Gravity | Ton) | Ton) | per Million) | Levels (%) | per Million) | Levels (%) |
| None | NA | 0.0 | 0.0 | 1,236 | 0.0 | 1,966 | 0.0 |
| Mineral Oil | 0.091 | 0.5 | 7.6 | 520 | 57.9 | 830 | 57.8 |
| DUSTROL 3088 | 0.924 | 0.5 | 7.7 | 310 | 74.9 | 685 | 65.2 |
| DUSTROL 3017 | 0.959 | 0.5 | 8.0 | 165 | 86.7 | 290 | 85.2 |
| Glycerin Citric Acid | 1.348 | 0.5 | 11.2 | 75 | 93.9 | 335 | 83.0 |
| (1 to 0.2) | | | | | | | |
| Glycerin Citric Acid | 1.357 | 0.5 | 11.3 | 50 | 96.0 | 315 | 84.0 |
| (1 to 0.8) | | | | | | | |

### Dust Tests with Di-Ammonium Phosphate

TABLE 5

| | | Application | Application | | | Total Dust | |
|---|---|---|---|---|---|---|---|
| | | Rate | Rate | Initial Dust | Reduction in | Levels after | Reduction in |
| | Specific | (Gallons per | (Pounds per | Levels (Part | Initial Dust | Aging (Part | Total Dust |
| De-Dusting Agent | Gravity | Ton) | Ton) | per Million) | Levels (%) | per Million) | Levels (%) |
| None | NA | 0.0 | 0.0 | 1,030 | 0.0 | 1,710 | 0.0 |
| Mineral Oil | 0.091 | 0.5 | 7.6 | 240 | 76.7 | 765 | 55.3 |
| DUSTROL 3088 | 0.924 | 0.5 | 7.7 | 180 | 82.5 | 550 | 67.8 |
| DUSTROL 3017 | 0.959 | 0.5 | 8.0 | 30 | 97.1 | 190 | 88.9 |
| Glycerin Citric Acid | 1.348 | 0.5 | 11.2 | 20 | 98.1 | 210 | 87.7 |
| (1 to 0.2) | | | | | | | |
| Glycerin Citric Acid | 1.357 | 0.5 | 11.3 | 5 | 99.5 | 320 | 81.3 |
| (1 to 0.8) | | | | | | | |

What is claimed is:

1. A dust control composition for solid granular materials, including fertilizers, aggregates, minerals and ores, comprising:
a composition for coating solid granular materials in which glycerin is reacted with a polybasic acid for producing said composition.

2. The composition according to claim 1, wherein the polybasic acid is citric acid.

3. The composition according to claim 1, wherein a ratio of the polybasic acid to glycerin is from about 0.05 to 1 to about 1 to 1.

4. The composition according to claim 3, wherein a desired application amount ranges from about 0.5 to 40 pounds per ton of fertilizer material.

5. A method for controlling dust and anti-caking of solid granular materials, including fertilizers, aggregates, minerals and ores, comprising:
applying to said fertilizer a coating composition comprising glycerin which has been reacted with a polybasic acid for producing said composition.

6. The method according to claim 5, wherein the polybasic acid is citric acid.

7. The method according to claim 5, wherein a ratio of the polybasic acid to glycerin is from about 0.05 to 1 to about 1 to 1.

8. The method according to claim 7, wherein a desired application amount ranges from about 0.5 to 40 pounds per ton of fertilizer material.
